(19) United States
(12) Patent Application Publication
(10) Pub. No.: US 2008/0059528 A1
(43) Pub. Date: Mar. 6, 2008

(54) Patient Care Order and Scanned Document Processing System

(75) Inventors: Alan M. Portnoy, Warwick, PA (US); John Elliott, Woodbury, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., Malvern, PA (US)

(21) Appl. No.: 11/847,811

(22) Filed: Aug. 30, 2007

Related U.S. Application Data
(60) Provisional application No. 60/823,932, filed on Aug. 30, 2006.
(60) Provisional application No. 60/826,122, filed on Sep. 19, 2006.

(51) Int. Cl. G06F 7/00

(52) U.S. Cl. 707/104.1

(57) ABSTRACT

A pharmacy information and scanned document processing system includes an input processor for receiving data representing a scanned image of a physician prepared order for a medication for a particular patient. At least one repository stores data associating scanned images, patients and electronic records of orders for medication. A data processor uses the at least one repository for associating a first identifier identifying the scanned image with a second identifier identifying a particular patient prior to associating the scanned image with an electronic record of an order for medication for the particular patient. A user interface processor provides data representing at least one display image presenting data indicating the scanned image is associated with a particular patient and in response to user selection of the scanned image, enabling a user to associate a first identifier identifying the scanned image with a second identifier identifying the electronic record of said order for the medication for the particular patient.

This is a non-provisional application of provisional application Ser. No. 60/823,932 filed Aug. 30, 2006 and of provisional application Ser. No. 60/826,122 filed Sep. 19, 2006 by A. M. Portnoy et al.

### FIELD OF THE INVENTION

The present invention relates to information processing systems in healthcare provider organizations, and in particular to systems for processing patient care orders and scanned documents.

### BACKGROUND OF THE INVENTION

Healthcare provider organizations, such as hospitals, use information processing systems for keeping track of many types of information. For example, admission, discharge and transfer (ADT) systems keep track of patient admissions, transfer and discharge. Financial information systems keep track of billing of patients, insurance companies, governmental agencies, guarantors and so forth. Other information processing systems include laboratory, imaging, pharmacy, etc. Typically these systems are relatively autonomous, and communicate by sending messages from one system to another.

One such system is a document management system. A document management system stores electronic copies of documents and provides characterization, indices and search capabilities to permit retrieval of document images when desired. For example, a physician may prescribe a medicine for a patient based on a patient visit. The prescription is typically written on a physician order form. The written physician order form is scanned into an image file at the nursing station. The written physician order is characterized and stored in the document management system.

In order to be filled, the prescription order image is communicated to another such system: a pharmacy information system (PIS). The order image may be viewed on a monitor by a pharmacist who fills the prescription. An electronic pharmaceutical order may be entered into the PIS based on the order image. The order image may also be annotated. For example, the pharmacist may place notes on the order. Such notes may relate to further information which may be required from the prescribing physician. The order may also be placed on ‘hold’, e.g. awaiting such further information, or for other appropriate reasons.

However, such systems typically do not link the order images in the document management system directly to pharmaceutical orders entered in the PIS. Instead, such a link is typically between the image and a patient record. Such systems also do not store images associated with a full medical record, e.g. in an enterprise document imaging system in the PIS. Further, such systems do not link pharmacist interventions or other clinical data in the PIS directly to an order image. In addition, the physician order image is not made available to bedside display devices for review or confirmation by nursing personnel. A system according to invention principles addresses these deficiencies and related problems.

### BRIEF SUMMARY OF THE INVENTION

In accordance with principles of the present invention, a patient care order and scanned document processing system includes an input processor for receiving data representing a scanned image of a physician prepared order for patient care for a particular patient. At least one repository stores data associating scanned images, patients and electronic records of orders for patient care. A data processor uses the at least one repository for associating a first identifier identifying the scanned image with a second identifier identifying a particular patient prior to associating the scanned image with an electronic record of an order for patient care for the particular patient. A user interface processor provides data representing at least one display image presenting data indicating the scanned image is associated with a particular patient and in response to user selection of the scanned image, enabling a user to associate the first identifier identifying the scanned image with a third identifier identifying the electronic record of the order for patient care for the particular patient.

A system according to principles of the present invention associates scanned images, or example physician pharmacy orders, provided by a document imaging system with pharmacy specific med/IV orders or other pharmacy specific data (e.g. pharmacist interventions, allergies, etc.). Workflow is streamlined because a medication order may be scanned and made immediately available to the pharmacist for review and processing. In addition, the order image may be linked to a specific pharmacy information system order so that the pharmacist may quickly reference the current image and all previous imaged orders associated with the pharmacy system order. The scanned order image may be accessed by selecting a link within the PIS, without the need to access and log into the document management system and then to navigate to the order image.

### BRIEF DESCRIPTION OF THE DRAWING

In the drawing:

FIG. 1 is a block diagram of a patient care order and scanned document processing system according to principles of the present invention;

FIG. 2 is a diagram illustrating the workflow for using a system according to the present invention;

FIG. 3 is a diagram illustrating a part of a user interface displaying an image of a summary of pharmacy orders, used in the system according to the present invention

FIG. 4 is a diagram illustrating a part of a user interface displaying an image of a physician handwritten order for medication for a patient, used in the system according to the present invention;

FIG. 5 is a diagram illustrating a part of a user interface displaying an image of an electronic record of a physician order for medication for a patient, used in the system according to the present invention; and

FIG. 6 illustrates display device configurations for displaying the user interface according to the present invention.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, patient care order and scanned document system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by the display processor under the control of the processor. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application manipulates the UI display images in response to the signals received from the input devices. In this way, the user interacts with the display image using the input devices, enabling user interaction with the processor or other device. A graphical user interface (GUI) uses graphical display images, as opposed to textual display images, when generating the UI.

A form, as used herein, is a type of UI display image. A form UI display image includes display elements, such as textual display, which prompt the user to enter particular information; and display elements, such as text boxes, check boxes etc., into which the user, using the input devices, may enter the particular information.

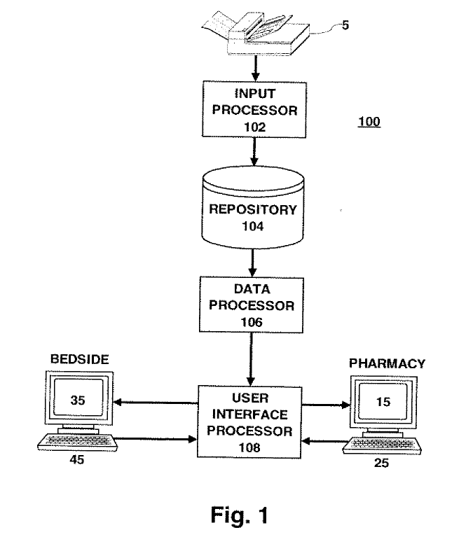

FIG. 1 is a block diagram of a patient care order and scanned document processing system 100 according to principles of the present invention. A patient care order and scanned document processing system 100 includes an input processor 102 for receiving data representing a scanned image of a physician prepared order for patient care for a particular patient. A scanner 5 provides a signal containing the data representing the scanned image to the input processor 102. At least one repository 104 stores data associating scanned images, patients and electronic records of orders for patient care. A data processor 106 uses the at least one repository 104 for associating a first identifier identifying the scanned image with a second identifier identifying a particular patient prior to associating the scanned image with an electronic record of an order for patient care for the particular patient. A user interface processor 108 provides data representing at least one display image presenting data indicating the scanned image is associated with a particular patient and in response to user selection of the scanned image, enabling a user to associate the first identifier identifying the scanned image with a third identifier identifying the electronic record of the order for patient care for the particular patient. The display image data is supplied to one or more display devices which display the image. In FIG. 1, a first display device 15 is located e.g. in a pharmacy, and a second display device 35 is located e.g. at a patient bedside care station. User input devices, operating with the respective display devices (e.g. 15, 35), provide data representing user input to the user interface processor 108. In FIG. 1, a first user input device 25, illustrated as a keyboard, operates with display device 15 and a second user input device 45 operates with display device 35

In one embodiment, the patient care and scanned document processing system 100 is a bedside care and scanned image processing system. In this embodiment, the input processor 102 receives data representing the scanned image of a treatment order for a particular patient. The at least one repository 104 stores data associating scanned images, patients and electronic records of treatment orders. The data processor 106 uses the at least one repository 104 for associating the first identifier identifying the scanned image with the second identifier identifying a particular patient prior to associating the scanned image with the electronic record of a treatment order for the particular patient. The user interface processor 108 provides data representing at least one display image presenting data indicating the scanned image is associated with a particular patient and in response to user selection of the scanned image, enables a user to associate the first identifier identifying the scanned image with the third identifier identifying the electronic record of the treatment order for the particular patient and enabling a user at a bedside care station to access the scanned image.

In another embodiment, the patient care and scanned document processing system 100 is a pharmacy information and scanned document processing system. In this embodiment, the input processor 102 receives data representing a scanned image of a physician prepared order for a medication for a particular patient. The at least one repository 104 stores data associating scanned images, patients and electronic records of orders for medication. The data processor 106 uses the at least one repository 104 for associating the first identifier identifying the scanned image with the second identifier identifying a particular patient prior to associating the scanned image with an electronic record of an order for medication for the particular patient. The user interface processor 108 provides data representing the at least one display image presenting data indicating the scanned image is associated with the particular patient and in response to user selection of the scanned image, enabling a user to associate the first identifier identifying the scanned image with the third identifier identifying the electronic record of the order for the medication for the particular patient.

The operation of the system illustrated in FIG. 1 is described below with respect to a pharmacy information system (PIS). One skilled in the art understands that operation with other information systems, such as a bedside point-of-care system, in a healthcare enterprise is similar and understands what modifications may be necessary to operate with other information systems.

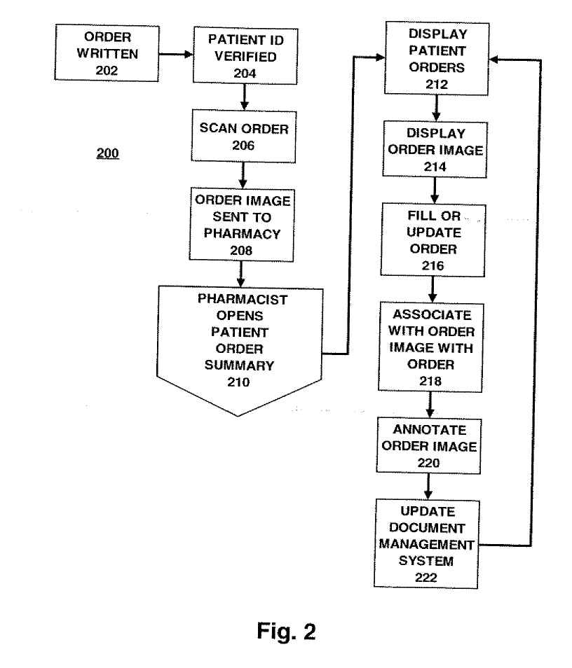

FIG. 2 is a diagram illustrating the workflow 200 for using a system according to the present invention. Referring concurrently to FIG. 1 and FIG. 2, in step 202 a physician prepares an order for medication for a particular patient. Typically the physician prepared order is a handwritten order on a standardized order form. In step 204 the identity of the patient for whom the order was prepared is verified, e.g. by inspecting a patient wrist band. If the patient identity is verified, in step 206 the nurse scans the handwritten order using the scanner 5. The scanner 5 provides a signal containing data representing the scanned image of the physician prepared order for medication for the particular patient to the input processor 102. The input processor 102 supplies that data to the repository 104 where it is stored, along with other associated data, including an identifier identifying the scanned order image. The data stored in the repository 104 further includes data associated with the patient (e.g. name, address, insurance, etc.), including an identifier identifying the patient. This data may be received from other information systems in the healthcare enterprise, such as the ADT information system. The data processor 106 associates the identifier identifying the order image with the identifier identifying the particular patient. Data representing the association is also stored in the repository 104.

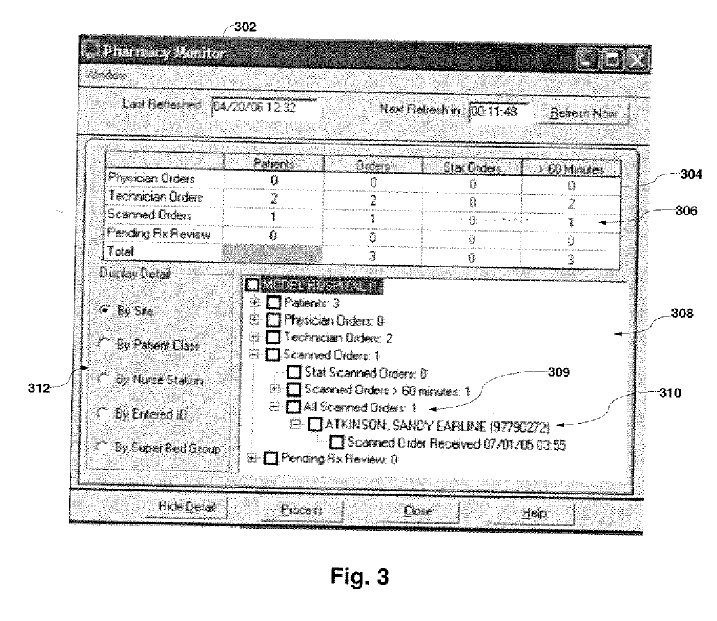

In step 208, the pharmacy information system is notified via an interface transaction from the document management system that a medication order has been scanned and is available for viewing. In step 210, the pharmacist opens the patient order summary user interface in the pharmacy information system. In step 212 the user interface processor 108 displays patient orders. FIG. 3 is a diagram illustrating a form 302 forming a part of a user interface used in the system 100 according to the present invention. The user interface processor 108 (FIG. 1) provides signals causing the display device 15 to display the form 302 illustrated in FIG. 3. The form 302 includes a first section 304 showing a summary of pending orders and reviews. In particular, line 306 provides an indication of the number of pending scanned orders, the number of stat orders and the number of non-stat (e.g. with permissible response times greater than 60 minutes) orders. A set 312 of radio buttons on the form 302 permits the pharmacist to sort and/or select orders for review by various criteria, such as by site, patient class, nurse station, entered ID, and super bed group. Other criteria (not shown) include sorting and/or selection by patient, physician, stat, non-stat, and so forth. The pharmacist may also take actions based on the order information, such as new orders, revised orders and/or discontinued orders. Actions taken on medication orders link order images with an electronic medication order record in the pharmacy information system in a manner described in more detail below.

The form 302 includes a second section 308 providing a user with more details about the orders summarized in the first section 304. Specifically, line 309 delineates a list of all scanned orders, and line 310 identifies a scanned order for patient “ATKINSON, SANDY EARLINE (9770272)”. A user, e.g. pharmacist, may select the order represented by this line for further processing. In step 214, when selected, the scanned order image represented by this line is retrieved from the repository 104 and displayed on the display device 15. Concurrently an electronic record of the order for medication is created in the pharmacy information system.

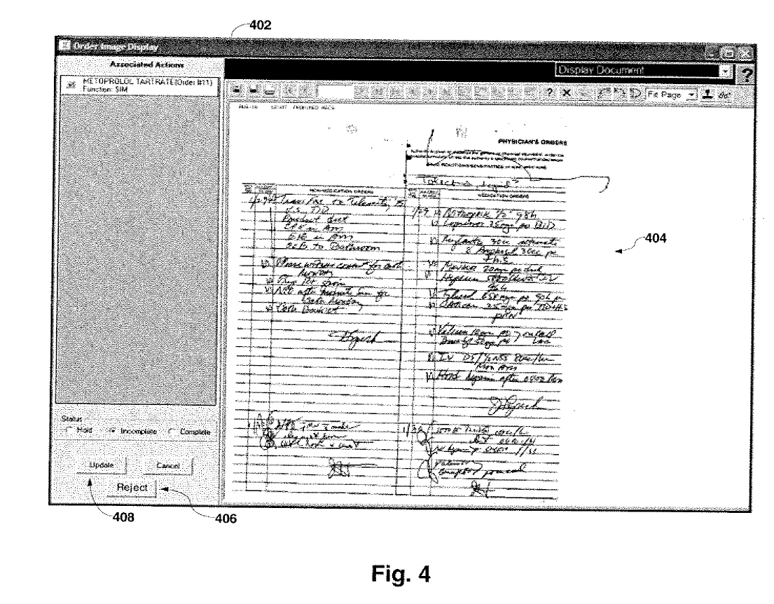

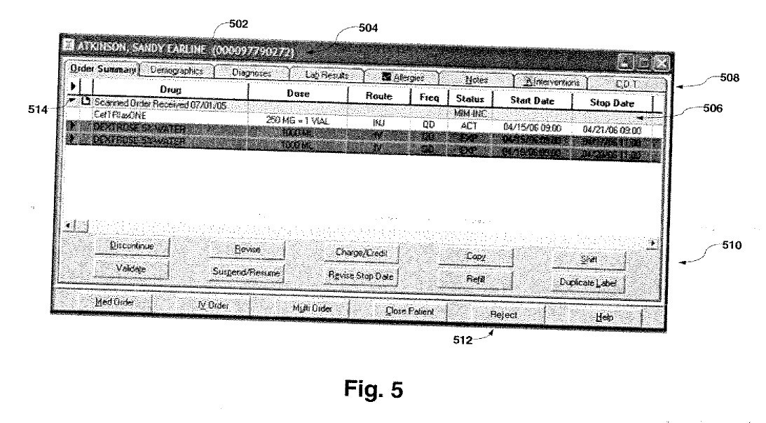

FIG. 4 is a portion 402 of a user interface displaying the scanned image 404 of a physician order for medication. A user, e.g. the pharmacist, may read the scanned order image 404, and may enlarge and pan the image to better see portions which may be hard to read at the normal size. FIG. 5 is a diagram illustrating a part of a user interface displaying an image of an electronic medication order 502 for a patient, displayed according to the present invention. The electronic medication order 502 is identified in the title bar 504 as related to the patient “ATKINSON, SANDY EARLINE (00009779272)”. A plurality of tabs 508 permit different aspects of the medication order to be displayed. In FIG. 5, a summary of the medication order is displayed. A plurality of buttons 510 permit the user to activate respective functions related to the medication order. A top line 506 indicates that the displayed medication order is a scanned order received on Jul. 1, 2005.

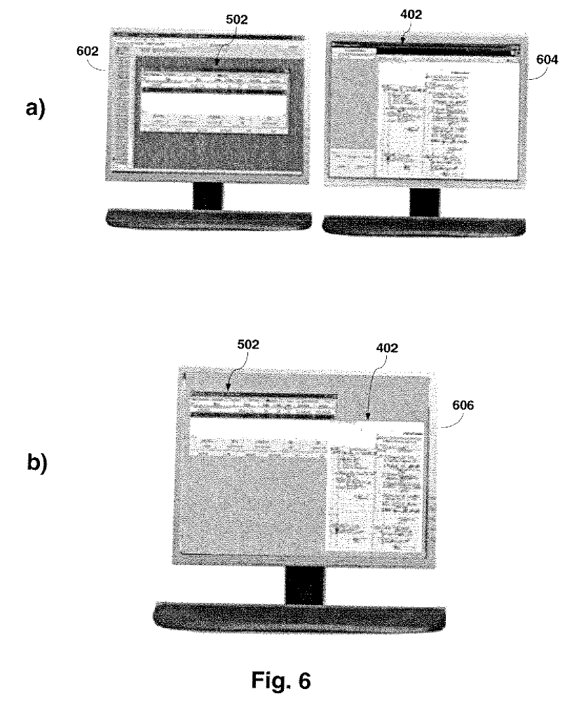

These user interface images 402 and 502, of FIG. 4 and FIG. 5 respectively, may be concurrently displayed, for example to verify that information in the electronic medication order 502 accurately reflects the physician's written order for medication 404 and/or allow the pharmacist to begin to fill the order. FIG. 6 illustrates display device configurations for displaying the user interface according to the present invention. In FIG. 6a, a first monitor 602 operates as a display device for displaying the electronic medication order 502 and a second monitor 604 operates as a display device for displaying the order image 402. In FIG. 6b, a single monitor 606 concurrently displays the electronic medication order 502 and the order image 402. One skilled in the art understands that other monitor configurations are possible.

In order to increase security and safety, the system 100 (FIG. 1) limits access to a single currently accessed scanned order image. This prevents the possibility of medication errors occurring due to a pharmacist inspecting a scanned order image for one patient while entering data into an electronic medication record for another patient; a situation which might arise if order images for more than one patient were concurrently displayed.

Referring again to FIG. 1 and FIG. 2, in step 216, the pharmacist fills or updates the medication order using the display images 402 and 502, of FIG. 4 and FIG. 5 respectively. This may involve providing the requested medication to the nursing station tending the patient. However, this may not be possible initially. For example, the pharmacist, upon reviewing the patient pharmacy record may find that there is a clinical problem concerning the order. For example, clinical intervention may be necessary to validate that the order should be processed; or the order may indicate: (a) a drug interaction condition, (b) an allergy condition, (c) an inappropriate prescription, and/or (d) a dosage problem. In this event, filling the order is deferred by the pharmacist. Further information may be requested by the pharmacist to permit filling of the order in a manner described in more detail below.

In step 218, in response to the display images 402, 502 (FIG. 4 and FIG. 5) presenting data indicating that the scanned order image 402 is associated with a particular patient (ATKINSON, SANDY EARLINE (000097790272) and in response to the user, e.g. pharmacist, selecting the scanned image, the user is enabled to associate the scanned order image 404 with the electronic medication order 502. As described above with respect to patient representative data and image representative data, the electronic record of the medication order also has an identifier identifying the electronic record of the medication order. The user interface processor 108 provides instructions to the data processor 106 conditioning it to associate the identifier identifying the scanned order image with the identifier identifying the electronic record of the medication order and to store data representing the association in the repository 104.

The UI display images may further present data representing a prompt to the user, e.g. the pharmacist, to confirm or reject the association of the scanned order image 402 with the electronic medication order 502. In FIG. 4, a “Reject” button 406 permits the user, e.g. pharmacist, to reject the association of the scanned order image 402 with the electronic medication order 502. Otherwise activation of the “Update” button 408 confirms the association. Similarly in FIG. 5, a “Reject” button 512 permits the user, e.g. the pharmacist, to reject the association of the scanned order image 402 with the electronic medication order 502. Activation of another button confirms the association, and performs the selected function.

Because the electronic record of the medication order resides in the pharmacy information system, the pharmacy information system may include a link to the handwritten order image and may access that image as desired. When an electronic medication order is created from a scanned order image, the data processor 106 automatically creates a universal resource locator (URL) link identifying the location of an order image in the repository 104. This URL may be associated with an image element in a UI form. In FIG. 5, an image element 514, in the form of a document icon, is displayed on line 506 representing the scanned order image. This URL link enables access by a user, e.g. a pharmacist, to the scanned image from the order display image 502 presenting data identifying the electronic record, in response to user activation of the image element 514, e.g. by clicking on the document icon 514.

As described above, a situation may exist in which the pharmacist cannot fill the order for medication for the particular patient. Also as described above, in this case, the pharmacist may request further information necessary to fill the medication order. In step 20, the pharmacist annotates the order image 404 (FIG. 4) to provide an indication of the problem, and places the order on hold until the problems are addressed. This order is then shown on the pharmacy order summary form 302 (FIG. 3) in the “Pending Rx Review” line.

In step 222, the document management system is updated with data representing the annotated scanned order image. At this point, the pharmacist returns to step 212 to review and process remaining medication orders. A clinician, e.g. the prescribing physician, may retrieve the annotated scanned order image from the repository 104, and provide the necessary information, or solve the indicated problems, and resubmit the order to the pharmacy.

Data representing the clinical problem, described above, forms ancillary data associated with the electronic medication order. Further ancillary data includes billing information concerning the order, and other such data. The user interface processor 108 enables a user to associate the identifier identifying the scanned order image with the third identifier identifying the electronic medication order record along with the ancillary information concerning the order. This data is gathered by the data processor 106 (FIG. 1), associated with the scanned order image and stored in the repository 104.

The system described above may also be extended to provide similar access to scanned medication order images at the patient bedside. A bedside care and scanned document processing system includes an input processor for receiving data representing a scanned image of a physician prepared order for a medication for a particular patient. At least one repository stores data associating scanned images, patients and electronic records of orders for medication. A data processor uses the at least one repository for associating a first identifier identifying the scanned image with a second identifier identifying a particular patient prior to associating the scanned image with an electronic record of an order for medication for the particular patient. A user interface processor provides data representing at least one display image presenting data indicating the scanned image is associated with a particular patient and in response to user selection of the scanned image, enables a user to associate a first identifier identifying the scanned image with a third identifier identifying the electronic record of the order for the medication for the particular patient and enabling a user at a bedside care station to access the scanned image.

Such a system operates in a similar manner to that illustrated in FIG. 1, FIG. 2, FIG. 3, FIG. 4, FIG. 5 and FIG. 6 and described in detail above. However, such a system operates in conjunction with a bedside care station including the display device 35 at the bedside of a patient. In this case, the user interface processor 108 provides user interface representative signals to the display device 35, and receives user input signals from the user input device 45, at the patient bedside care station enabling a user at a beside care station to access the scanned medication order image. This permits nursing personnel to review the scanned medication order image prior to providing medication to a patient. Specifically, the user interface enables a user, e.g. a nurse, access to scanned images of previous treatment orders associated with the order for medication for the particular patient. The user interface also enables user access to status information of the order for medication for the particular patient to determine: (a) that the order has been processed by the pharmacist, and/or (b) whether processing of the order is delayed pending clarification by a physician. Such a system further enables a user access to the scanned medication order image at the bedside care station during update of a patient record to document administration of the order for medication to the particular patient.

A system according to principles of the present invention has been described above primarily in relation to a pharmacy information system. One skilled in the art understands that the ability to associate a document, such as a scanned written order for medication, in a healthcare enterprise document management system with records in other associated but relatively autonomous information systems, such as a pharmacy information system, permits faster and more accurate exchange of information between those systems. This results in faster and more efficient administration of healthcare to patients because a user of one information system (e.g. pharmacy information system) has access to information which had previously been available only in the other system and was not available without logging into the other system (which may not be possible if the user is not authorized to access that system).

What is claimed is:

1. A patient care order and scanned document processing system, comprising:
an input processor for receiving data representing a scanned image of an order for patient care for a particular patient;
at least one repository for storing data associating scanned images, patients and electronic records of orders for patient care;
a data processor for using said at least one repository for associating a first identifier identifying said scanned image with a second identifier identifying a particular patient prior to associating said image with an electronic record of an order for patient care for said particular patient; and
a user interface for providing data representing at least one display image presenting data indicating said scanned image is associated with a particular patient and in response to user selection of said scanned image, enabling a user to associate said first identifier identifying said scanned image with a third identifier identifying said electronic record of said order for said patient care for said particular patient.

2. A system according to claim 1, wherein said patient care and scanned document processing system is a bedside care and scanned image processing system, wherein:
said input processor receives data representing said scanned image of a treatment order for a particular patient;
at least one repository stores data associating scanned images, patients and electronic records of treatment orders;
said data processor uses said at least one repository for associating said first identifier identifying said scanned image with said second identifier identifying a particular patient prior to associating said scanned image with said electronic record of a treatment order for said particular patient; and
said user interface processor provides data representing at least one display image presenting data indicating said scanned image is associated with a particular patient and in response to user selection of said scanned image, enabling a user to associate said first identifier identifying said scanned image with said third identifier identifying said electronic record of said treatment order for said particular patient and enabling a user at a bedside care station to access said scanned image.

3. A system according to claim 1 wherein said patient care and scanned document processing system is a pharmacy information and scanned document processing system, wherein:
said input processor receives data representing a scanned image of a physician prepared order for a medication for a particular patient;
said at least one repository stores data associating scanned images, patients and electronic records of orders for medication;
said data processor uses said at least one repository for associating said first identifier identifying said scanned image with said second identifier identifying a particular patient prior to associating said scanned image with an electronic record of an order for medication for said particular patient; and
said user interface provides data representing said at least one display image presenting data indicating said scanned image is associated with said particular patient and in response to user selection of said scanned image, enabling a user to associate said first identifier identifying said scanned image with said third identifier identifying said electronic record of said order for said medication for said particular patient.

4. A system according to claim 3, wherein said physician prepared order is a handwritten order.

5. A system according to claim 3, wherein said system limits access to a single currently accessed scanned image.

6. A system according to claim 3, wherein said at least one display image presents data representing a prompt to a user to confirm or reject association of said scanned image with said electronic record of said order for said medication.

7. A system according to claim 3, wherein said data processor automatically creates a URL enabling access by a user to said scanned image from an order display image presenting data identifying said electronic record, in response to user selection of an image element representing said created URL in said order display image.

8. A pharmacy information and scanned document processing system, comprising:
an input processor for receiving data representing a scanned image of a physician prepared order for a medication for a particular patient;
at least one repository for storing data associating scanned images, patients, electronic records of orders for medication and ancillary information;
a data processor for using said at least one repository for associating a first identifier identifying said scanned image with a second identifier identifying a particular patient prior to associating said scanned image with an electronic record of an order for medication for said particular patient; and
a user interface processor for providing data representing at least one display image presenting data indicating said scanned image is associated with a particular patient and in response to user selection of said scanned image, enabling a user to associate said first identifier identifying said scanned image with a third identifier identifying said electronic record of said order for said medication for said particular patient and with ancillary information concerning said order.

9. A system according to claim 8, wherein said ancillary information concerning said order comprises at least one of: (i) a clinical problem concerning said order, and (ii) billing information concerning said order.

10. A system according to claim 9, wherein said clinical problem concerning said order indicates clinician intervention is necessary to validate said order is to be processed.

11. A system according to claim 9, wherein said clinical problem concerning said order indicates at least one of: (a) a drug interaction condition, (b) an allergy condition, (c) an inappropriate prescription, and (d) a dosage problem.

12. A bedside care and scanned document processing system, comprising:
an input processor for receiving data representing a scanned image of a physician prepared order for a medication for a particular patient;
at least one repository for storing data associating scanned images, patients and electronic records of orders for medication;
a data processor for using said at least one repository for, associating a first identifier identifying said scanned image with a second identifier identifying a particular patient prior to associating said scanned image with an electronic record of an order for medication for said particular patient; and
a user interface processor for providing data representing at least one display image presenting data indicating said scanned image is associated with a particular patient and in response to user selection of said scanned image, enabling a user to associate a first identifier identifying said scanned image with a third identifier identifying said electronic record of said order for said medication for said particular patient and enabling a user at a bedside care station to access said scanned image.

13. A system according to claim 12, wherein said user interface enables user access to said scanned image at a bedside care station during update of a patient record to document administration of said order for medication to said particular patient.

14. A system according to claim 12, wherein said user interface enables user access to scanned images of previous treatment orders associated with said order for a medication for a particular patient.

15. A system according to claim 12, wherein said user interface enables user access to status information of said order for a medication for a particular patient to determine at least one of: (a) said order has been processed by a pharmacist, and (b) processing of said order is delayed pending clarification by a physician.
